(19) United States
(12) Patent Application Publication
(10) Pub. No.: US 2004/0160463 A1
(43) Pub. Date: Aug. 19, 2004

(54) System and method for displaying menu information in an electronic display

(76) Inventors: Amy E. Battles, Windor, CO (US); K. Douglass Gennetten, Ft. Collins, CO (US); Robert Paul Cazier, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 10/368,232

(22) Filed: Feb. 18, 2003

(51) Int. Cl. G09G 5/00

(52) U.S. Cl. 345/814

(57) ABSTRACT

A novel visual-display system and associated method have improved menu management. In one embodiment, the visual-display system comprises a display defining a viewing area, logic configured to display a plurality of user-selectable menu options in the viewing area, logic configured to display at least one selectable menu option in a first display mode, and logic configured to display the at least one selectable menu option in a second display mode, in response to a time-out period. The at least one selectable menu option, when displayed in the second display mode, is less obstructive of the non-menu display information provided in the display, than when displayed in the first display mode.

### BACKGROUND OF THE INVENTION

1. Field of the Invention

The present invention relates to display systems and, more particularly, to a system and method for displaying menu information in an electronic display.

2. Discussion of the Related Art

A variety of electronic devices are known, which have displays, such as an LCD (liquid crystal display) panel for displaying information to a user. Many such devices provide an ever-increasing amount of user-controllable functions. With regard to user-controllable functions, devices typically have some sort of manual inputs (e.g., buttons, switches, etc.) through which a user provides control input to the device. Often, information is visually provided to the user through menu options or other information provided on the display.

In the case of many portable electronic devices, the display often provides other information for viewing by the user, and when a control mode is entered, menu options or other information may be displayed on a display by superimposing that information over the information that is otherwise displayed. For example, in the case of a digital camera, the display typically provides a visual display of information as obtained through a lens or viewfinder of the camera. When a control mode is entered to allow a user to change or effect settings of the camera, control or manipulate information within the camera, or otherwise interface with the camera, menu options are often provided on the display superimposed over the non-menu information otherwise presented to the user. Of course, this menu information that is superimposed over the typical display information obstructs the view thereof, and is often undesirable.

### SUMMARY OF THE INVENTION

Accordingly, it is desired to provide a system for displaying menu information in an electronic display that reduces the amount of interference or obstruction by the menu items of the non-menu information. Accordingly, the present invention is directed to a novel visual-display system having improved menu management. In one embodiment, the visual-display system comprises a display defining a viewing area, logic configured to display a plurality of user-selectable menu options in the viewing area, logic configured to display at least one selectable menu option in a first display mode, and logic configured to display the at least one selectable menu option in a second display mode, in response to a time-out period. The at least one selectable menu option, when displayed in the second display mode, is less obstructive of the non-menu display information provided in the display, than when displayed in the first display mode.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1A is a diagram illustrating the display of a plurality of symbols and associated text in a first display mode of one embodiment of the invention.

FIG. 1B is a diagram illustrating the display of a plurality of symbols and a single text menu option in a second display mode of the embodiment of FIG. 1A.

FIGS. 2, 3, 4, and 5 are diagrams illustrating possible second display modes, or third display modes, of the embodiment illustrated in FIG. 1A.

FIG. 6A is a diagram illustrating the display of a plurality of symbols and associated text menu options in a first display mode, similar to the embodiment of FIG. 1A.

FIGS. 6B and 6C are diagrams illustrating a plurality of symbols and associated text for a display as presented in a second display mode for the embodiment of FIG. 6A.

FIG. 7 is a diagram illustrating a potential third display mode of the embodiment of FIG. 6A.

FIG. 8A is a diagram of a display presenting a plurality of text menu options in a first display mode in accordance with another embodiment of the invention.

FIG. 8B is a diagram illustrating the presentation of the menu options of FIG. 8A in a second display mode.

FIG. 9A is a diagram illustrating a plurality of text menu options in a first display mode of another embodiment of the present invention.

FIGS. 9B and 9C are diagrams illustrating the presentation of the plurality of text menu options of FIG. 9A in accordance with a second display mode.

FIG. 10 is a diagram illustrating the presentation of a plurality of symbols corresponding to a plurality of the text menu options of FIG. 9A, in accordance with a possible third display mode.

FIGS. 11A and 11B are diagrams illustrating the presentation of a plurality of symbols and associated text menu options in a first display mode and second display mode, respectively, in accordance with another embodiment of the present invention.

FIGS. 12A and 12B are diagrams illustrating the display of a plurality of menu options, in a first display mode and a second display mode, respectively, similar to those illustrated in FIGS. 1A and 1B, wherein the menu options are presented in a different orientation within the display.

FIGS. 13A, 13B, and 13C are diagrams illustrating the display of a plurality of menu options, in a first display mode, second display mode, and third display mode, respectively, in accordance with another embodiment of the invention.

FIG. 14 is a block diagram showing certain components of one embodiment of the present invention, as embodied in a portable electronic device.

FIG. 15 is a block diagram illustrating certain components within functional/operational display logic of one embodiment of the present invention.

FIG. 16 is a block diagram illustrating certain components that may be embodied within logic that controls a second display mode in accordance with an embodiment of the invention.

FIGS. 17 and 18 are flowcharts illustrating certain steps within the functional operation of two embodiments of the present invention.

### DETAILED DESCRIPTION OF THE PREFERRED EMBODIMENT

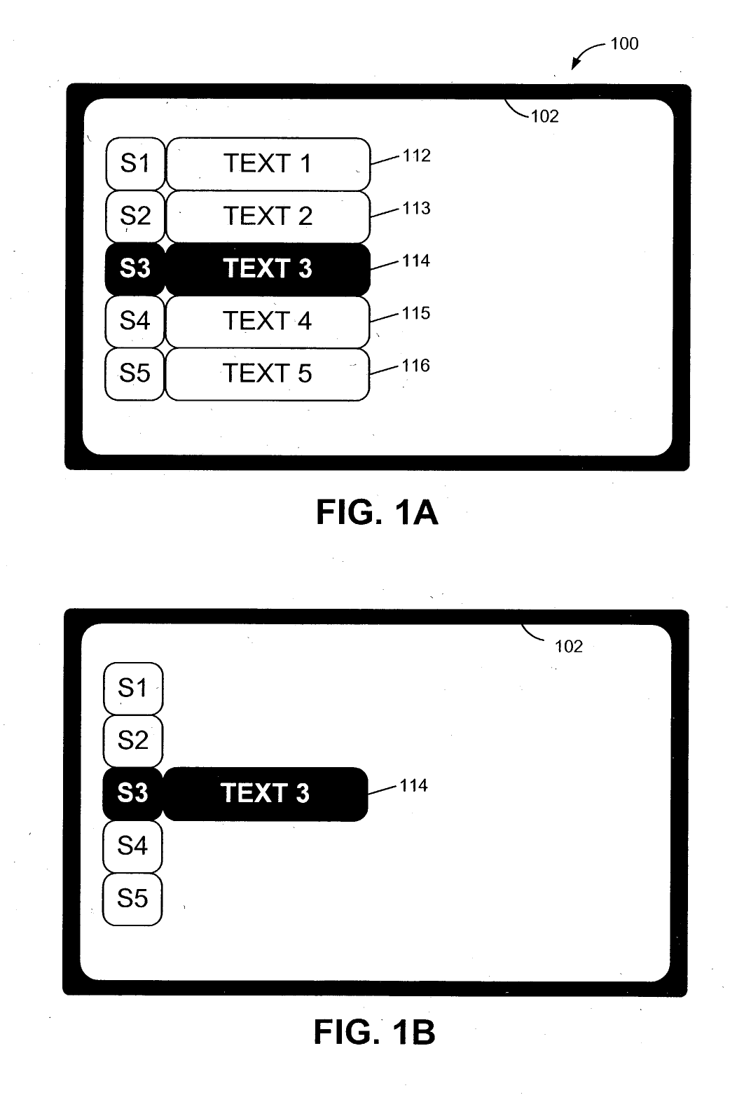

As summarized above, the present invention is directed to a novel method and apparatus for displaying menu information in an electronic display in such a way as to reduce the obstruction, by the, menu information, of information otherwise presented within the display. Before describing various embodiments of the invention, it is noted that the invention has broad applicability to a variety of electronic devices. One contemplated type of device would be any of a variety of portable electronic devices, such as digital cameras, video cameras, cellular phones, personal digital assistants (PDAs), etc. Reference is now made to the drawings, which illustrate certain features and operations of various embodiments of the present invention. In this regard, FIGS. 1A through 12B generically depict various alternative implementations for presenting menu options of a display in first display modes, second display modes, and optional third display modes.

In accordance with one aspect of the present invention, menu information is first presented to a user in a first display mode. Although not specifically shown in the drawings, it will be appreciated that a menu presentation may be invoked by the user be depressing a designate button or other input control. In the first display mode, sufficient descriptive information is provided for each of the menu options to clearly instruct the user as to the purpose and/or function of the respective menu options. This generally requires that more information be presented to the user, by superimposing that information over the non-menu information that is otherwise presented within the display. Consequently, the non-menu information within the display is obstructed. After a period of time, such as several seconds, the menu information enters a second display mode, in which the menu information is presented to the user in a less-obstructive fashion. Generally, the less-obstructive fashion is achieved through the use of symbols, abbreviations, reduced font size in text, placement of information in peripheral or less obstructive locations of the display, such that the menu information is not as obstructive of the non-menu information provided on the display. The diagrams of FIGS. 1A through 12B illustrate several ways in which menu information may be presented in first display modes, second display modes, and optional third display modes in accordance with the invention. It should be appreciated, however, that these diagrams are not deemed to be limiting, or by any means exhaustive, of the numerous alternative implementations that are consistent with the scope and spirit of the present invention.

Turning first to FIG. 1A, FIG. 1A is a diagram of a display 100 having a viewing area defined by border 102. The viewing area is the area in which visual information may be presented to a user. The visual information that is presented to the user will, of course, depend upon the electronic device and the normal purpose or function of the display. For example, in a digital camera, the visual information may comprise information that is seen or captured through a lens or viewfinder, or alternatively may comprise a previously-captured digital image or video. The presentation of this type of information on displays is well known, and therefore is not described herein. Further, the diagrams of FIGS. 1A through 12B do not illustrate this non-menu information. However, it should be understood that this information may be presented within the display 100 within the viewing area 102, in ways that are known and understood in the art. Further, it should be understood that the display 100 may be any of a number of types of displays, such as a liquid crystal display (LCD), a plasma display, an organic light-emitting diode display (OLED), or any of a variety of other well-known displays.

In the specific embodiment of FIG. 1A, five menu options are depicted generically. As presented in a first display mode of the embodiment of FIG. 1A, these five menu options are represented both graphically in the form of symbols S1 through S5 and associated Text 1 through Text 5. By way of illustration, in a given application, one menu option may be an option to delete. The symbol for this menu option may be a miniature trash can, and the associated text may be “delete.” Since there are virtually an endless number of symbols and functions which may be embodied in menu options, and since the present invention is not limited to any particular menu option or function, the drawings herein represent these menu options generically. In one embodiment, for any given list or plurality of menu options, there may be a single menu option that is currently active. In this regard, a currently-active menu option is one that is immediately selectable by the user for implementation. In one embodiment, the display may identify a currently-active menu option by highlighting that menu option, either through a different color, inverting the colors, or otherwise. In the drawings herein, currently-active menu options are illustrated through white text on a black background, while the remaining, non-currently-active menu options are illustrated with black text on a white background. Accordingly, in FIG. 1A, menu option 114 is the currently-active menu option.

Although the diagram of FIG. 1A is not necessarily to scale, it is observed that the menu options, including both symbols and associated text, may take up a significant portion of the viewing area 102 of the display 100. Generally speaking, this is undesirable. Accordingly, in accordance with one embodiment of the invention, after displaying the menu options in the first display mode of FIG. 1A for a period of time (e.g., several seconds), the display enters a second display mode, illustrated in FIG. 1B, in which the text portions of the non-currently-active menu options are removed from the display. Presenting the full text of the menu options for several seconds allows the user to ascertain the functions available in the particular menu screen, such that after several seconds, the text of the remaining menu options may be removed with the symbols S1, S2, S4, and S5 (in the illustrated embodiment) being sufficient to keep the user apprised of the other options available. Although not specifically illustrated in the drawings of this embodiment, the user may, through manual controls or otherwise, change the designation on the currently-active menu option from the third menu option to the second menu option. In one embodiment, when displaying the menu information in the second display mode, the symbol and text 113 for that menu option would be presented in the viewing area 102 of the display, and the text 114 of the third menu option would be removed. In an alternative embodiment, a change in the currently-active menu option may operate to reset the timeout period to revert to a first display mode.

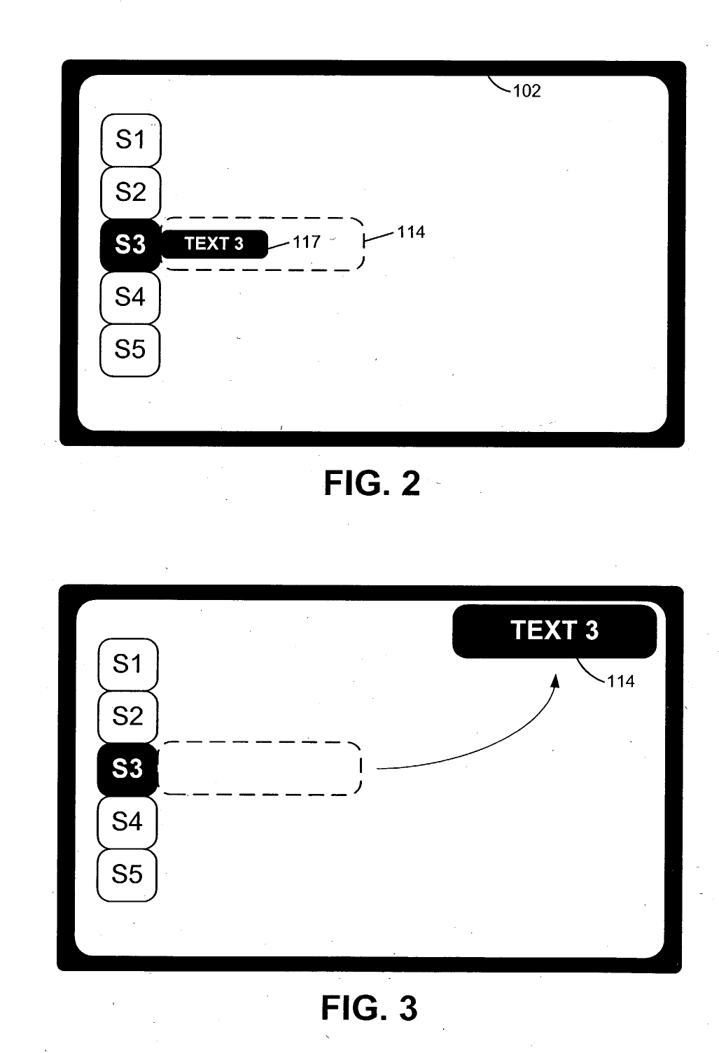

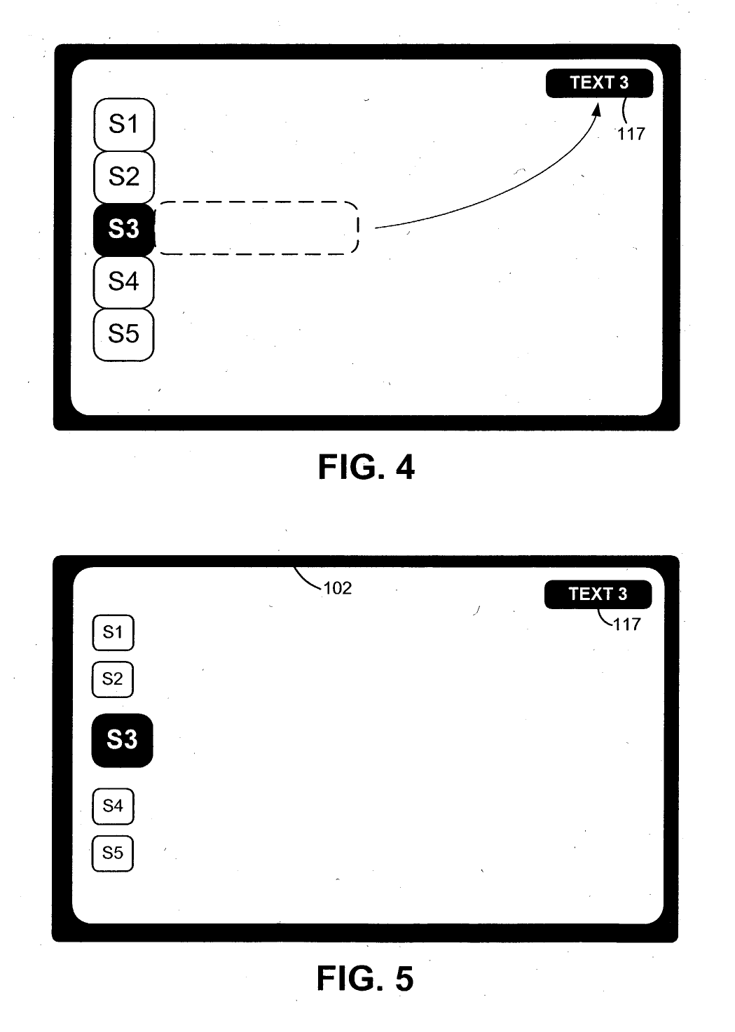

Reference is now made to FIGS. 2, 3, 4, and 5, which illustrate alternative second display modes (or optional third display modes) for the embodiment of FIG. 1A. As shown in the diagram of FIG. 2, in addition to removing the text portions of the menu options for the non-currently-active menu options, the text portion for the currently-active menu option may be reduced in size 117. The size reduction may be implemented by abbreviating the text for the menu option or by simply shrinking the font size of the text for the menu option. Alternatively, the text portion for the currently-active menu option may be moved from a location that is substantially adjacent the symbol S3 for the currently-active menu option to a location near the periphery of the viewing area 102 (see FIG. 3). Although the text portion 114 of the menu option may occupy the same amount of physical space, by moving the text portion to a peripheral location within the viewing area, it may be less obstructive to the substantive content of the non-menu information within the display. In yet another embodiment (illustrated in FIG. 4), the text portion 117 of the currently-active menu option may be both reduced in size and relocated to a less obstructive portion of the viewing area of the display.

In one implementation, the alternatives illustrated in FIGS. 2, 3, and 4 may be implemented as a second display mode, instead of that illustrated in FIG. 1B. Alternatively, in another embodiment, the second display mode may be implemented in FIG. 1B, and after an additional time-out period (e.g., several more seconds), the display may enter a third display mode, which further reduces the amount of display obstruction through the menu items. In such an embodiment, any of the alternatives of FIGS. 2, 3, and 4 may be implemented.

FIG. 5 is a diagram illustrating a potential third display mode, which may be implemented in certain embodiments. The layout for the third display mode similar to that illustrated in FIG. 4, wherein symbols S1 through S5 are shown, and the text 117 of the currently-active menu option is displayed in a remote corner of the viewing area 102. However, different from the illustration of FIG. 4, the icons or symbols S1, S2, S4, and S5 of the non-currently-active menu options are reduced in size. Of course, the size of the currently-active menu option S3 may be reduced in size as well.

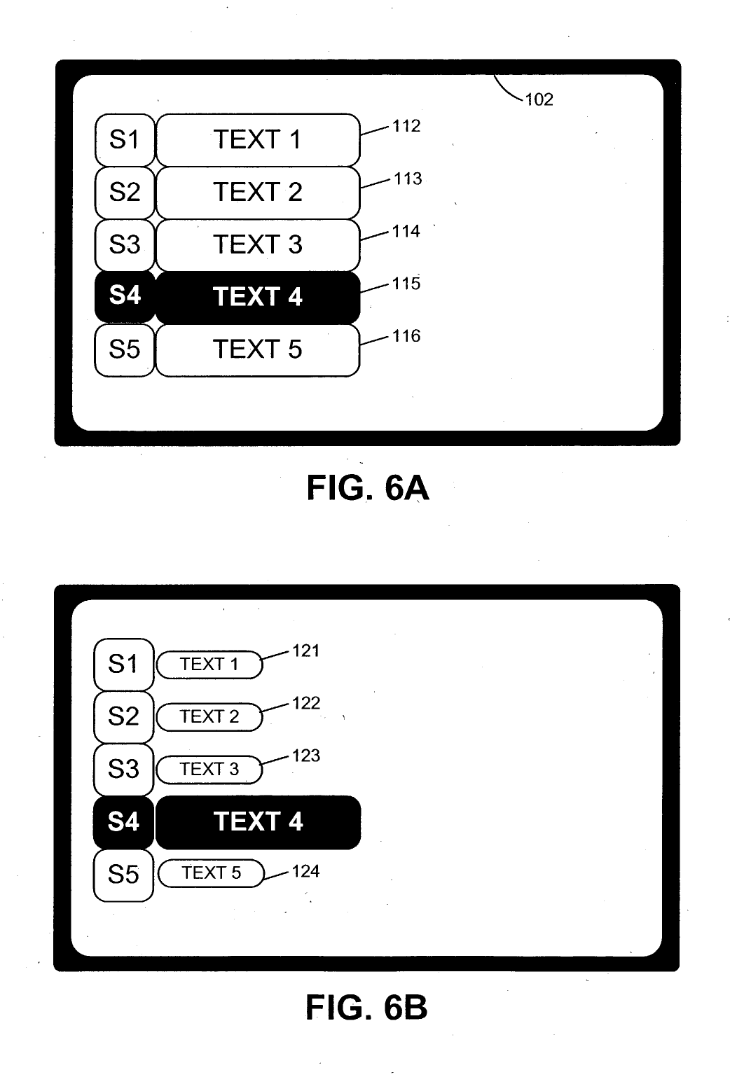

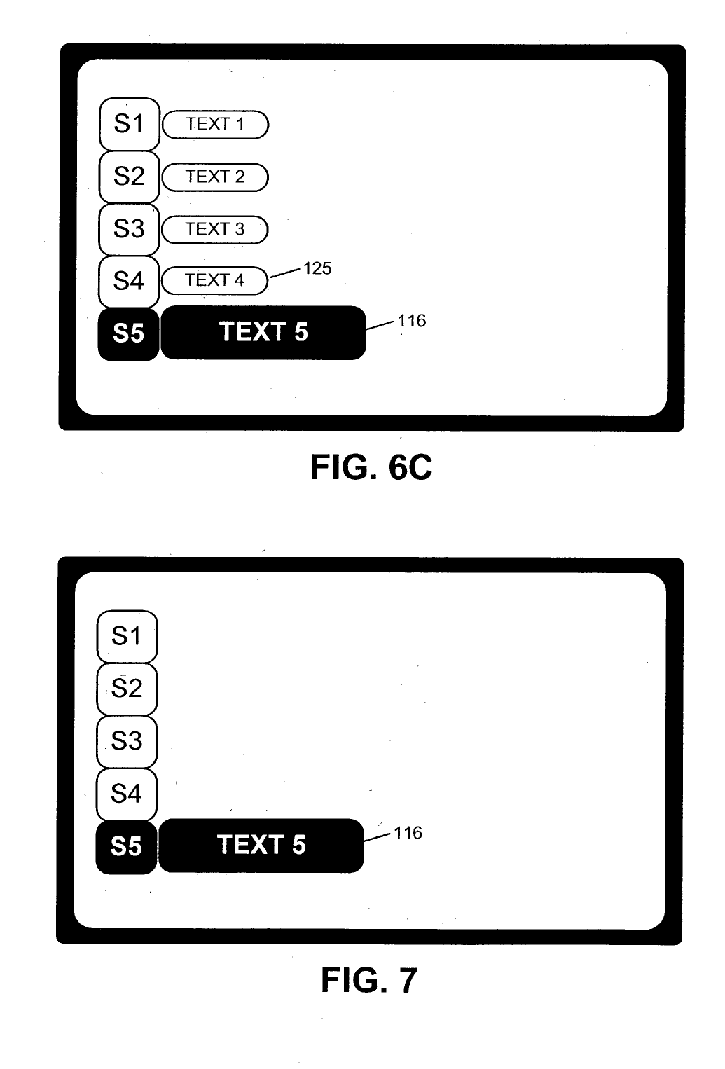

Again, the diagrams illustrated in FIGS. 1A through 5 are only a few of many numerous display alternatives, which may be implemented in accordance with the present invention. Another such alternative is illustrated in FIGS. 6A through 6C. FIG. 6A illustrates a display presenting a plurality of menu options similar to that illustrated in FIG. 1A. In the illustration of FIG. 6A, the fourth menu option (S4 and Text 4) 115 is the currently-active menu option. In a second display mode (illustrated in FIG. 6B), the text portions 121, 122, 123, and 124 of the non-currently-active menu options may be reduced in size so as to reduce the amount that they obstruct the viewing area 102. FIG. 6C illustrates a potential implementation of the second display mode of this embodiment if the user were to change the currently-active menu option from the fourth option to the fifth option. Specifically, the text portion 125 of menu option 4 is reduced in size, while the text portion 116 of the fifth menu option is displayed in its full or normal size.

As illustrated in FIG. 7, a third display mode may be optionally provided, in which the text portion of the non-currently-active menu options are removed from the display, thereby further reducing the obstruction of the information otherwise presented within the viewing area 102 of the display.

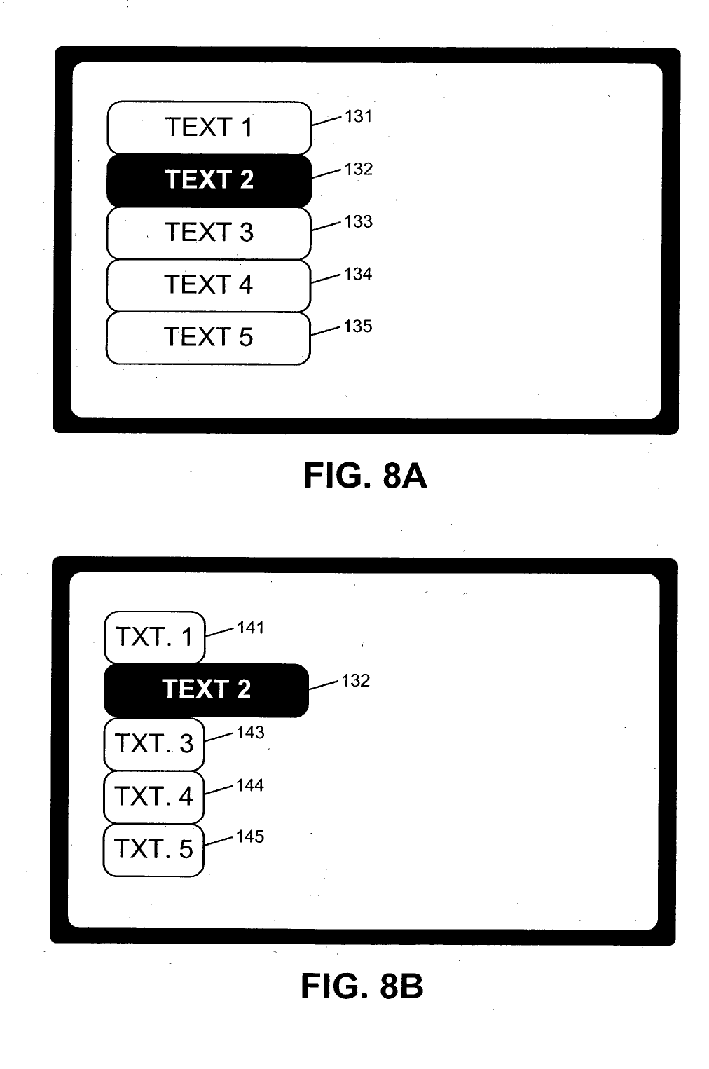

Reference is now made to FIGS. 8A and 8B, which illustrate the first display mode and second display mode of yet another embodiment of the invention. In this embodiment, menu options 131, 132, 133, 134, and 135 are presented in text only, and no icons or symbols associated with the menu options are displayed. After displaying for several seconds in a first display mode (a sufficient amount of time for the user to read the various menu options), the display enters a second display mode in which the size of the non-currently-active menu options 141, 143, 144, and 145 are reduced in size by abbreviating the text.

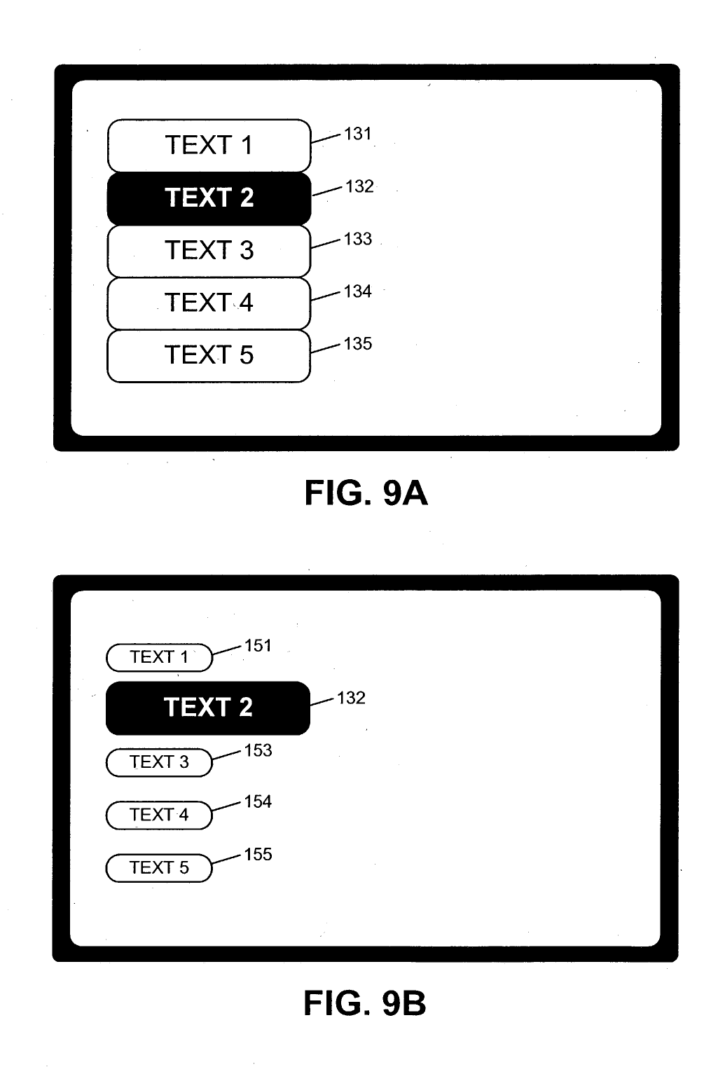

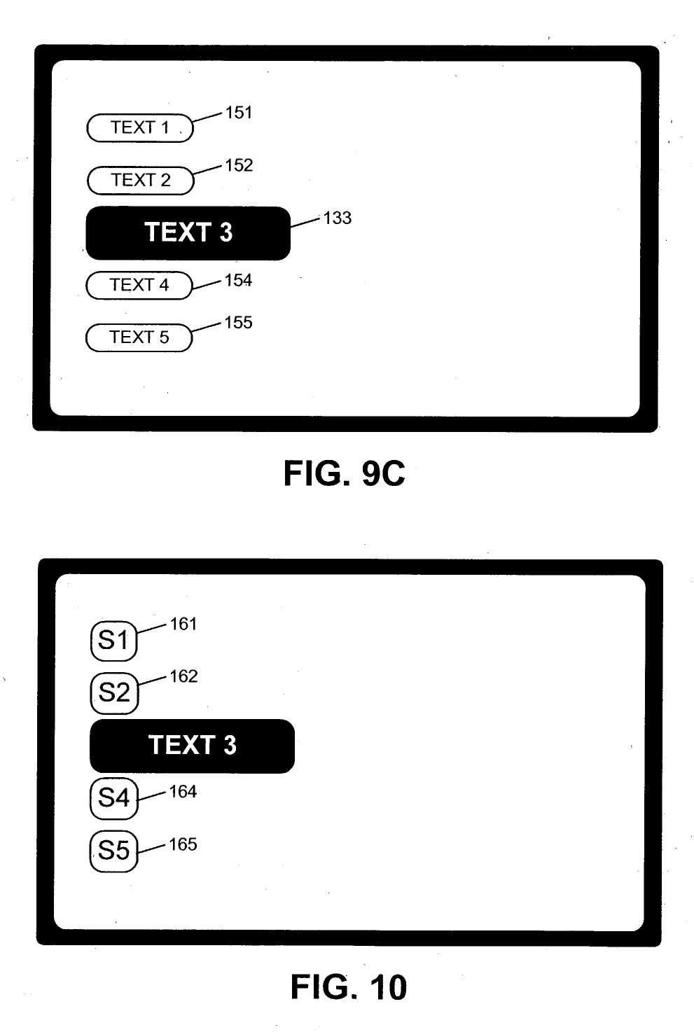

A similar embodiment is illustrated in FIGS. 9A through 9C. Specifically, the first display mode of FIG. 9A shows five menu options presented in text only, as shown in FIG. 8A. After several seconds have transpired, and the display enters the second display mode, the non-currently-active menu options 151, 153, 154, and 155 are reduced in size. Unlike the implementation illustrated in FIG. 8B, where the size reduction is achieved by abbreviating the text, the size reduction of the embodiment of FIG. 9B is achieved by reducing the font size of the text. As illustrated by the difference between FIGS. 9B and 9C, as a user changes the currently-active menu option from the second option to the third option, the text portion of the third option expands to its normal size, while the text portion of the second option is reduced to a size similar to the other non-currently-active menu options.

FIG. 10 illustrates an optional third display mode, which may be implemented in connection with the embodiment of FIGS. 9A through 9C. In this mode, after the menu options have been presented in the second display mode for several seconds (or some other predetermined amount of time), the presentation of the non-currently-active menu options may be further reduced in size by removing the text of the menu options and replacing the text with associated symbols 161, 162, 164, and 165.

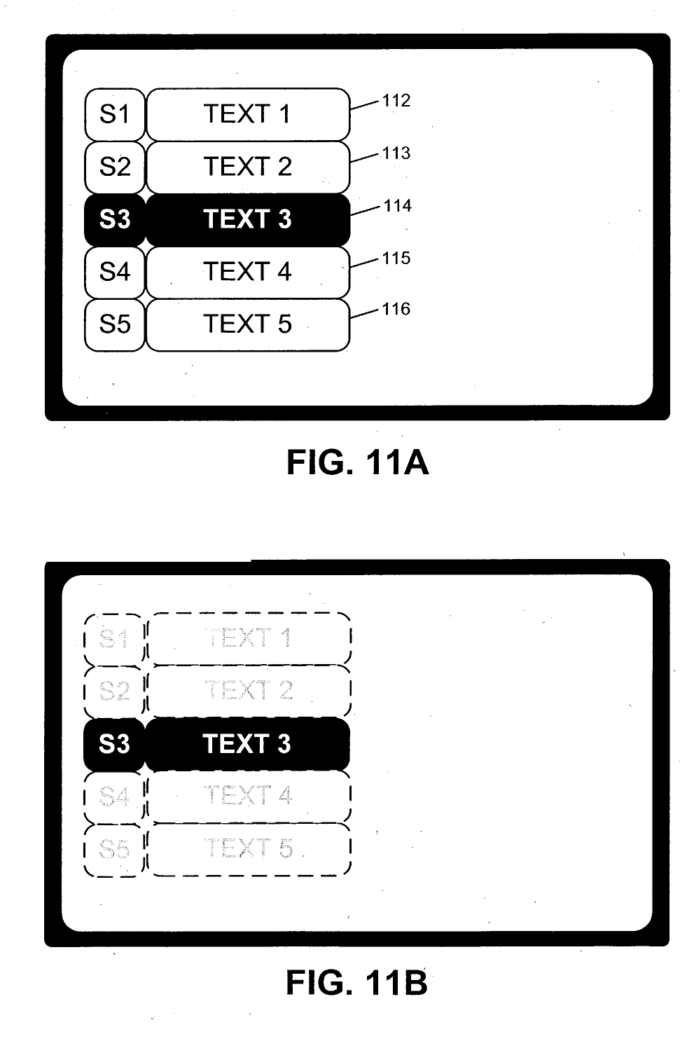

Reference is now made to FIGS. 11A and 11B, which illustrate yet another implementation of the present invention. FIG. 11A illustrates the presentation of a plurality of menu options in the same manner as presented in FIG. 1A. After displaying these menu options in the first display mode for several seconds, a second display mode is entered in which only the currently-active menu option is displayed and, both the text and symbol portions of all remaining menu options are removed (illustrated by dash lines in FIG. 11B). In an alternative implementation, rather than completely remove the non-currently-active menu options from the display, they may be displayed in a translucent fashion, such that they do not completely obstruct the information otherwise presented in the display.

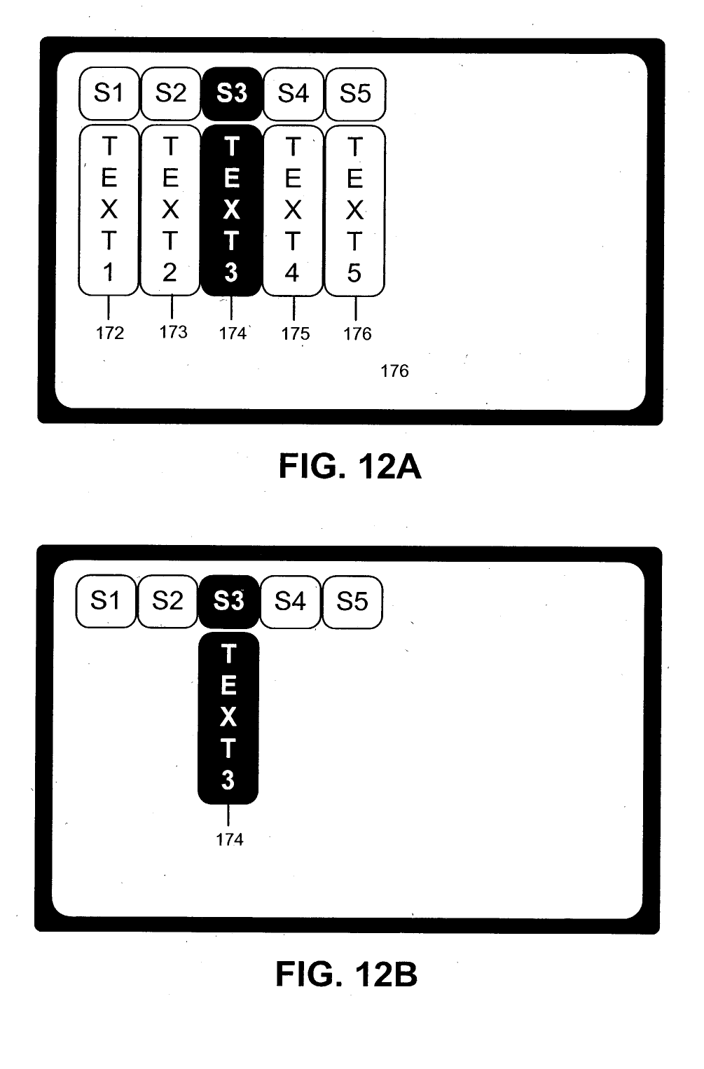

In accordance with yet another implementation of the present invention, first and second display modes may be presented as illustrated in FIGS. 12A and 12B, respectively. Like FIG. 1, the first display mode illustrated in FIG. 12 presents a plurality of menu options in both symbol form S1, S2, S3, S4 and S5, and associated text 172, 173, 174, 175, and 176. Like the second display mode illustrated in FIG. 1B, the second display mode of the embodiment of FIG. 12 removes from the display the text portions of all non-currently-active menu options. The difference between the embodiments of FIGS. 1 and 12 is merely in the orientation of the menu options within the display.

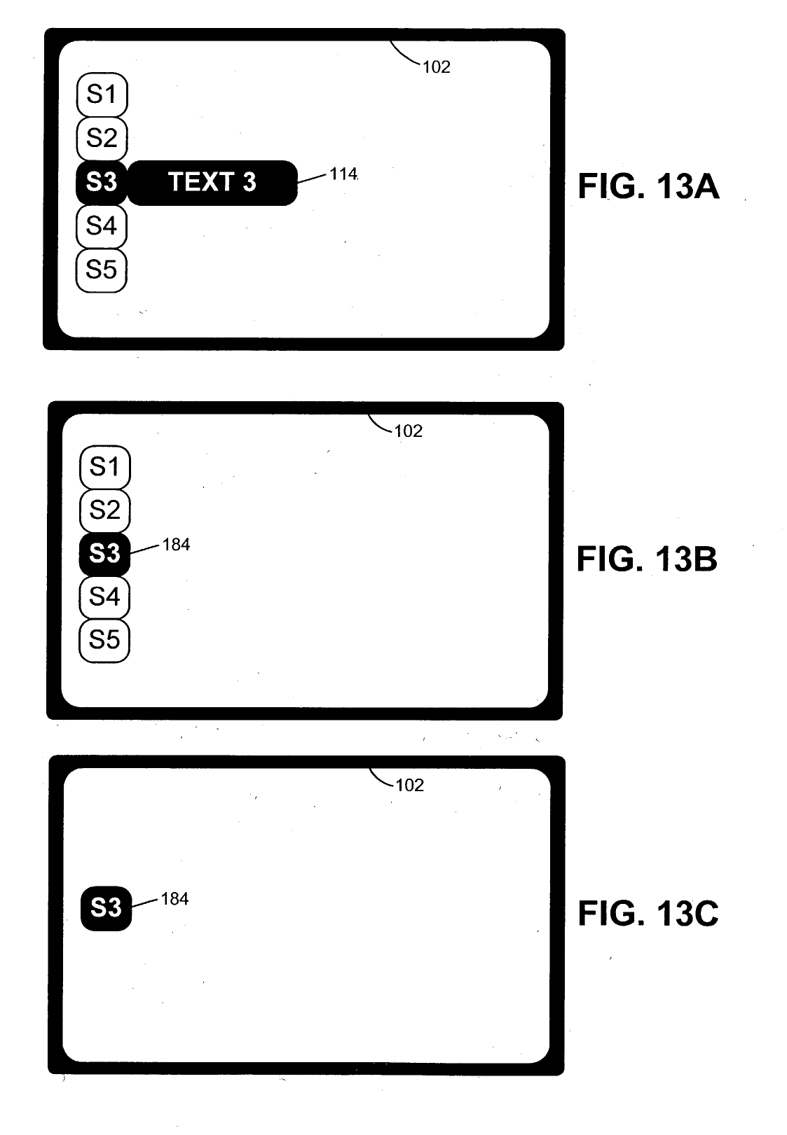

In accordance with another embodiment of the invention, first, second, and third display modes may be presented as illustrated in FIGS. 13A, 13B, and 13C. In a first display mode of this embodiment, a plurality of icons are illustrated, and the text of a currently-active menu item 114 are displayed (preferably in a translucent fashion overlying the subject matter of the display). After a timeout period of menu inactivity, the display switches to a less obstructive, second display mode (FIG. 13B), in which the text of the currently-active item is removed. In this second display mode, only the menu icons are displayed, with the menu item 184 of the currently-active item being emphasized. After a further timeout period, the display switches to an even less obstructive, third display mode (FIG. 13C). In this mode, the icons representing the non-currently active menu items are removed, leaving only the icon of the currently-active menu item for display. Thereafter, or at any point of the display, if the user selects an alternative menu item, the timeout periods are reset, and the display presents the menu in the form of FIG. 13A.

As previously noted, the diagrams of FIGS. 1A through 13C have presented only a few examples of a virtually endless variety of implementations of features of the present invention. In accordance with the scope and spirit of the preferred embodiment, menu information is presented to a user within the viewing area of a display in a first display mode for a period of time. After this period of time has past, the menu information is presented in a second display mode that is less obstructive of the viewing area and therefore less obstructive of the non-menu content that is otherwise displayed therein. In certain embodiments, third and fourth display modes may be provided after respective time-out periods in which progressively less and less of the display is obstructed by the menu information. With regard to the time-out periods, they may vary from embodiment to embodiment, depending upon the number and content of the menu options being presented. Further, the time-out periods may be fixed for a given device and/or menu, or alternatively may be user-selectable, such that a user may define whether the first display mode comprises three seconds or twenty seconds, for example.

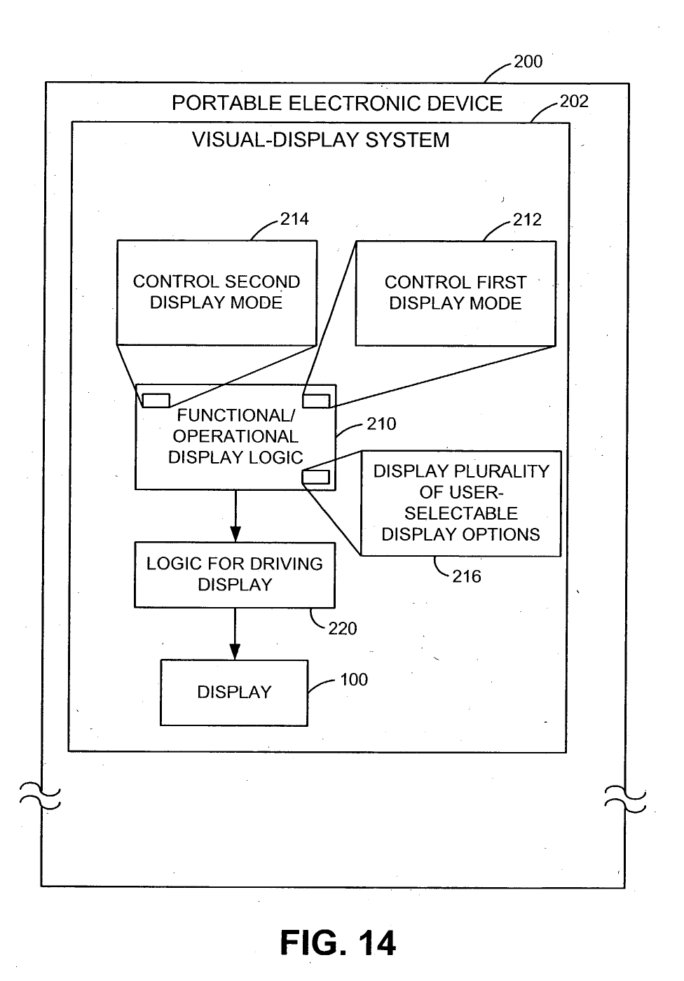

Reference is now made to FIG. 14, which is a block diagram illustrating certain components within a portable electronic device 200 constructed in accordance with one embodiment of the present invention. As previously mentioned, the present invention may be implemented in a variety of electronic devices, including portable electronic devices. A portable electronic device 200 embodying the present invention includes a visual-display system 202. Within the visual-display system 202, is a display 100, and logic for driving the display to 220. These components may be implemented through conventional and well-known devices and techniques, and therefore are not further described herein. Also provided within the visual-display system 202 is functional or operational display logic 210. This functional display logic includes the logic (hardware, software, or a combination of the two) for controlling the content of information that is provided on the display 100. Much of this logic may be implemented in conventional and well-known ways. However, at least a portion of this functional display logic 210 includes components that are unique to the illustrated embodiment of the present invention. For example, the functional display logic 210 includes logic 212 to control the display of information in a first display mode. The functional display logic 210 also includes logic 214 to control the display of information in a second display mode. In concert with these functional logic blocks, the functional display logic 210 also includes logic 216 for controlling the display of a plurality of user-selectable display options. The logic blocks 212 and 214 operate to control the display of menu options in first and second display modes as described in connection with FIGS. 1A through 12B. The display of menu information, via superimposing menu options over the non-menu content of a display is well-known, and therefore need not be described herein. Indeed, persons skilled in the art will understand and appreciate manners of implementing the logic 212 and 214 in view of the remaining discussion provided herein.

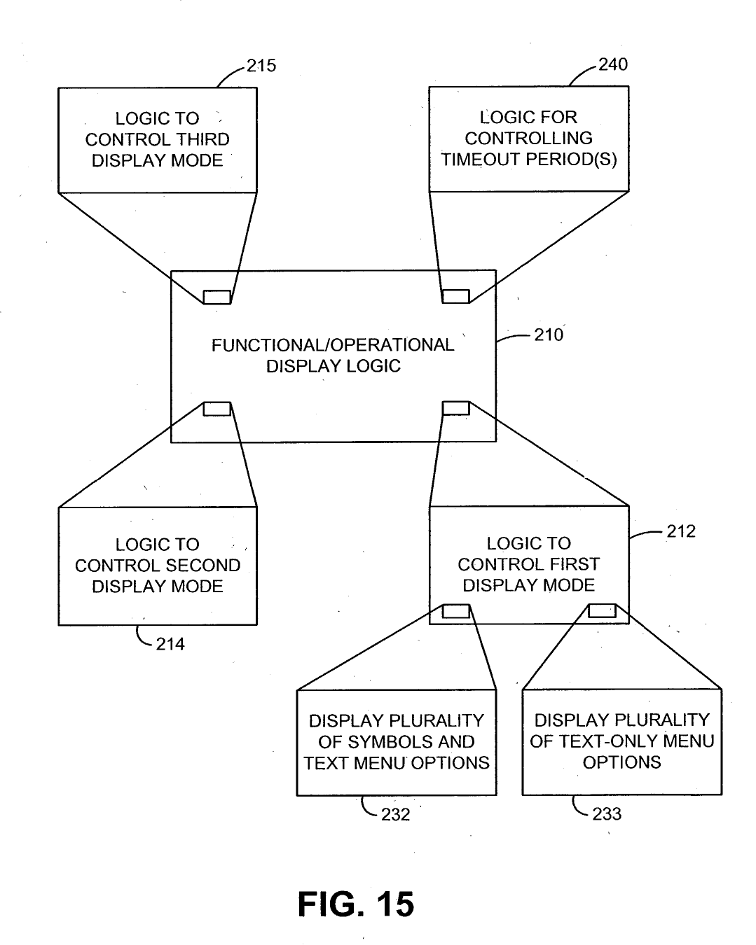

Reference is now made to FIG. 15, which is a block diagram showing additional logic components associated with the functional display logic 210. In addition to the logic 212 and 214 for controlling the first and second display modes, similar logic 215 may be provided for controlling the display in a third display mode (such as the third display modes described above). Logic 240 may also be provided for managing or controlling the time-out periods for the first, second, third, or other display modes. As mentioned above, the time-out periods may be implemented in a variety of ways. In one embodiment, the time-out periods may be fixed for the device. In another embodiment, the time-out periods may be user-definable. In one embodiment, once a user has activated a menu, such that menu information is presented on a display, the menu is presented in a first display mode for a first time-out period, after which the menu is presented in a second display mode. In one embodiment, the time-out periods may be reset or restarted as a user scrolls through menu options, or designates new currently-active menu options. In another embodiment, the designation of new currently-active menu options do not affect or restart time-out periods.

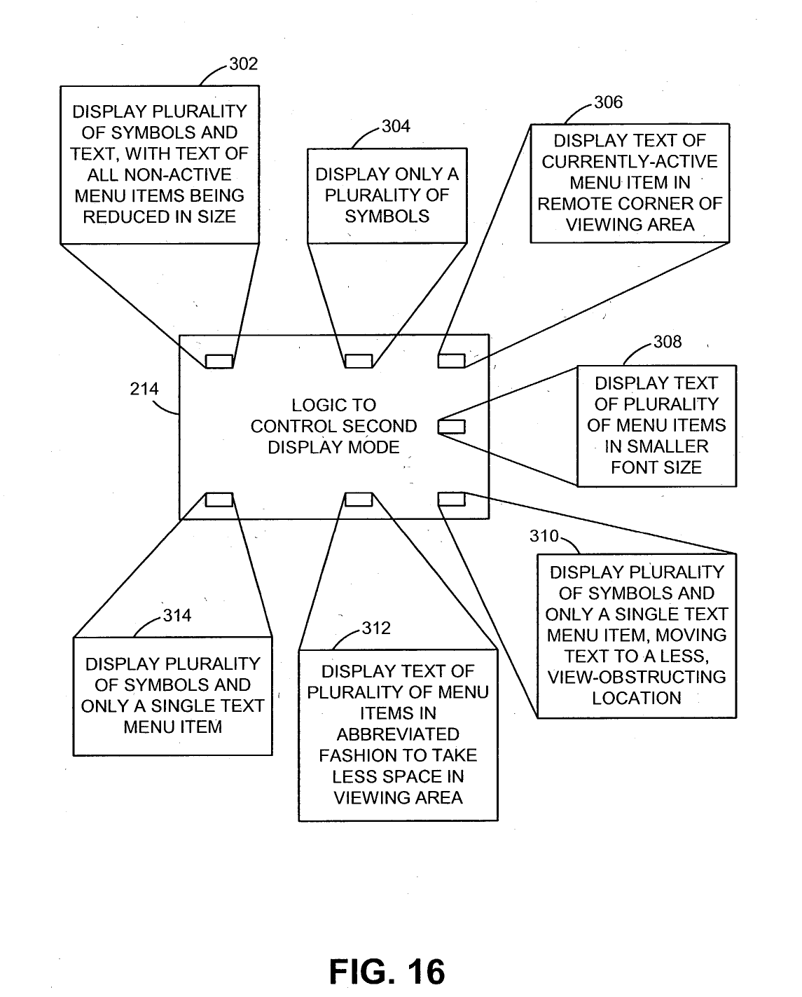

As illustrated in, FIG. 15, the logic 212 for controlling the first display mode may include components for displaying a plurality of symbols and text menu options 232, and for displaying a plurality of text-only menu options 233. Of course, other components may be provided and associated with the logic 212 as well. With regard to the logic 214 for controlling the second display mode, reference is made to FIG. 16. Consistent with the various embodiments described above, the logic 214 for controlling the second display mode may include a variety of components, a few of which are illustrated in FIG. 16. These components may include a component for displaying a plurality of symbols and text, with the text of all non-currently-active menu items being reduced in size (e.g., FIG. 6B). Another component 304 may be configured to control the display to display only a plurality of symbols (e.g., FIG. 5). Another component 306 may be configured to control the display to present the text of currently-active menu items in a remote corner of the viewing area of the display (e.g., FIG. 3). Another component 308 may be provided to control the display to present text of a plurality of menu items in a smaller font size (e.g., FIG. 6C). Another component 310 may be provided to control the display to present a plurality of symbols and only a single text menu item, and further moving the text to a less view-obstructing location (e.g., FIG. 4). Another component 312 may be provided to control the display to present the text of a plurality of menu items in an abbreviated fashion, in order to take less space in the viewing area (e.g., FIG. 8B). Another component 314 may be provided to control the display to present a plurality of symbols in only a single text menu item (e.g., FIG. 1B). Of course, a variety of other components, not specifically illustrated herein, may be provided as a part of the logic 214 in order to implement the various embodiments illustrated herein, as well as the virtually countless other embodiments not specifically illustrated or described herein, consistent with the scope and teachings of the present invention.

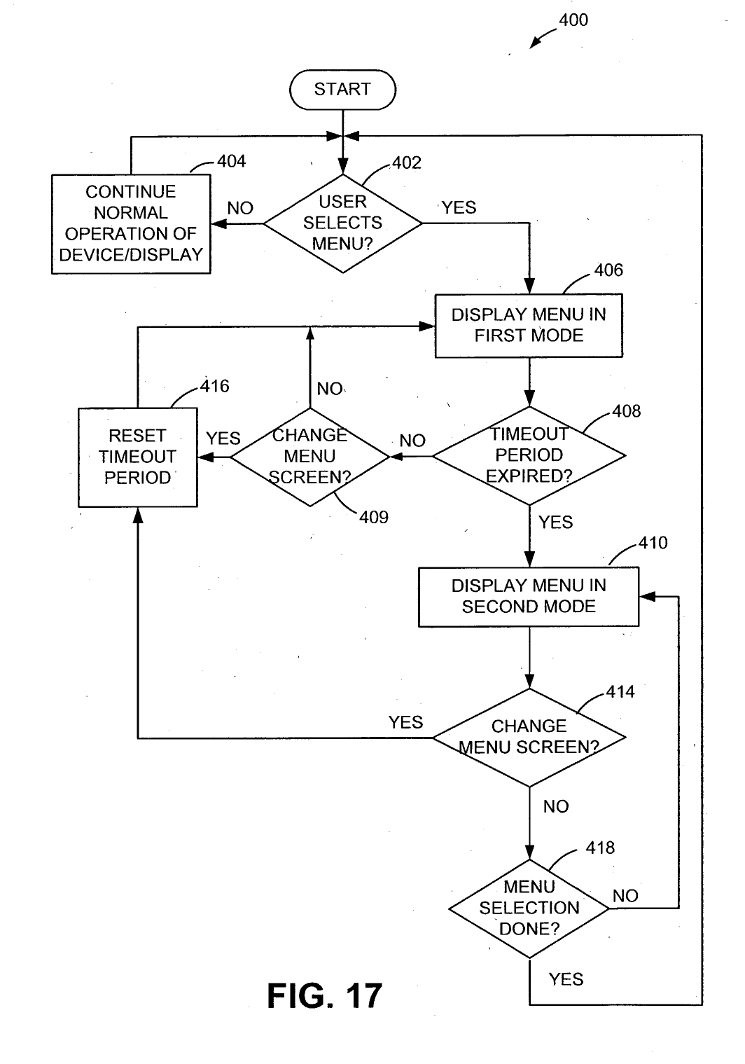

Reference is now made to FIG. 17, which is a flowchart 400 illustrating certain steps of a method constructed in accordance with one embodiment of the invention. The relevant portion of this method initiates when a user, through manual inputs, invokes a menu to be presented on a visual display (step 402). If no menu invocation is encountered, then the device will continue with its normal or conventional functional operation (step 404). Once, however, a user invokes a menu to be presented on the display, then menu options (e.g., a list of a plurality of menu options) are displayed in a first display mode (step 406). The menu options will continue to be displayed to the user in this display mode until a time-out period has occurred (step 408). In one embodiment, however, it may be desired to reset the time-out period (step 416) if a user, through manual controls or otherwise, changes the menu screen, such that a new set of menu options is presented to a user. (step 409). Alternatively, it may be desired to reset the timeout period upon merely a change in the currently-active menu selection. By resetting the time-out period, this presents the new menu items to the user in the first display mode for the full amount of time designated for the first display mode. As noted above, this may be a constant period, it may be a user-definable period, or it may be a period that varies for each menu screen, depending upon the content of a given menu screen. Further, the design determination as to whether the timeout period, of one or more of the display modes, is reset upon a change in a currently-active menu selection or a change to the entire menu display may vary from embodiment to embodiment. For example, in an embodiment like that illustrated in FIG. 1A, where the entire text of all menu options is displayed to the user in the first display mode, it may be desired not to reset the first timeout period upon merely a change in a currently-active menu item, but rather only upon a change in the entire menu screen. In an embodiment like that if FIG. 13A, however, which presents the text of only the currently-active menu option, then it may be desired to reset the timeout period (of the first display mode) upon a change in the currently-active menu selection. Implementation details such as these are not to be construed as limiting upon the invention, except as they may be expressly recited in the claims.

Once the time-out period (step 408) has expired, then the menu information is presented to the user in a second display mode (step 410). As described herein, the particular presentation of the menu information in the second display mode may vary significantly from embodiment to embodiment. Generally, however, the second display mode presents the menu information in a less obstructive fashion than the information was presented in the first display mode. If there are no third or subsequent display modes, the menu information will continue to be displayed to the user until either the user has directed a change in the menu screen (step 414), or until the user has completed the menu-selection process (step 418). The menu-selection process may be determined by affirmative user input, or may be defined by a timeout period.

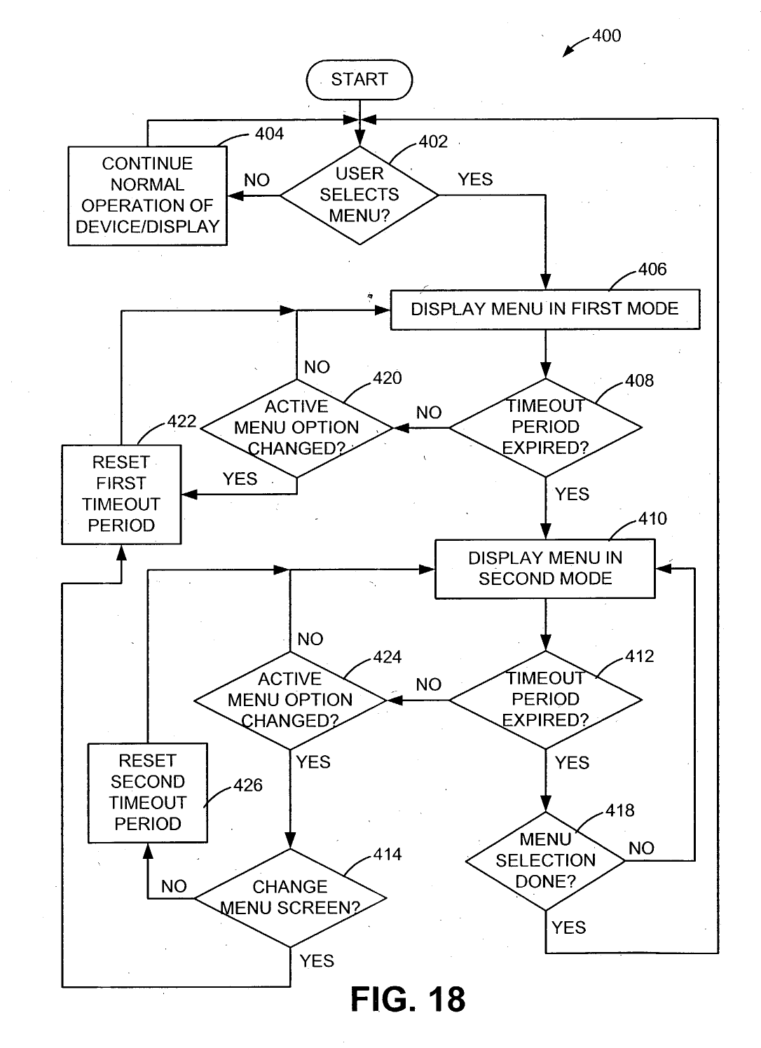

Reference is now made to FIG. 18, which is a flowchart of a similar, but alternative embodiment of the present invention. For ease and illustration, certain blocks on the flowchart of FIG. 17 have been eliminated (e.g., step 409), but may be implemented consistent with the embodiment illustrated in FIG. 18. The steps that were described in FIG. 17, and which are implemented in a similar fashion have been assigned the same reference numbers in FIG. 18, and the description of their operation will not be redescribed in connection with this figure.

One principal change reflected in the embodiment of FIG. 18 relates to the reset of the time-out period when a user changes a currently-active menu option. For example, when displaying information in a first display mode, and before the time-out period for the first display mode has expired (step 408), if the user changes the currently-active menu option (step 420), and the method may reset the first time-out period (step 422) and continue displaying the menu information in the first display mode (step 406). As noted in connection with FIG. 17, such a reset of the timeout may occur if either the currently-active menu item is changed or alternatively only upon a change of the entire menu.

The foregoing embodiments and descriptions were presented herein for illustration purposes only, and it should be appreciated by persons skilled in the art that a variety of other options and embodiments may be implemented consistent with the scope and spirit of the present invention.

What is claimed is:

1. A visual-display system comprising:
a display defining a viewing area;
logic configured to display a plurality of selectable menu options in the viewing area;
logic configured to display at least one selectable menu option in a first display mode; and
logic configured to display the at least one selectable menu option in a second display mode in response to a timeout period;
wherein the at least one selectable menu option occupies less space in the viewing area of the display when displayed in the second display mode than when displayed in the first display mode.

2. The visual-display system of claim 1, wherein the first display mode is defined by the display of text for each of a plurality of menu items and the second display mode is defined by the display of text for only a single, currently-active, menu item.

3. The visual-display system of claim 2, wherein the first display mode is further defined by the display of a symbol for each of the plurality of menu items, and the second display mode is defined by the display of a symbol for each of the plurality of menu items.

4. The visual-display system of claim 2, wherein, in the second display mode, text for the currently-active menu item is displayed adjacent the symbol associated with the currently-active menu item.

5. The visual-display system of claim 2, wherein, in the second display mode, text for the currently-active menu item is displayed near a corner of the viewing area of the display.

6. The visual-display system of claim 1, wherein the first display mode is defined by the display of a symbol for each of a plurality of menu items and also the display of text for only a single, currently-active, menu item in a first text-display size, and the second display mode is defined by the display the text for the currently-active menu item in second text-display size, wherein the second text-display size is smaller than the first text-display size.

7. The visual-display system of claim 6, wherein the second text-display size is displayed in a smaller font than a font of the first text-display size.

8. The visual-display system of claim 6, wherein the text of the second text-display size is an abbreviated representation of the text of the first text-display size.

9. The visual-display system of claim 1, wherein the first display mode is defined by the display of a symbol for each of a plurality of menu items and also the display of text for only a single, currently-active, menu item in a first text-display location, and the second display mode is defined by the display the text for the currently-active menu item in second text-display location, wherein the second text-display location is different than the first text-display location.

10. The visual-display system of claim 9, wherein, in the first text-display location is substantially adjacent the symbol for the currently-active menu item and the second text-display location is near a corner of the viewing area of the display.

11. The visual-display system of claim 1, wherein the first display mode is defined by the display of a symbol and associated text for a single, currently-active, menu item, and the second display mode is defined by the display of only the symbol of the single, currently-active, menu item.

12. The visual-display system of claim 1, wherein the first display mode is defined by the display of text for a single, currently-active, menu item in a first text-display size, and the second display mode is defined by the display of the text of the single, currently-active, menu item in a second text-display size.

13. The visual-display system of claim 1, wherein the first display mode is defined by the display of text for a single, currently-active, menu item in a first text-display location, and the second display mode is defined by the display of the text of the single, currently-active, menu item in a second text-display location.

14. The visual-display system of claim 1, further comprising logic configured to display the at least one selectable menu option in a third display mode in response to a second timeout period, wherein the at least one selectable menu option occupies less space in the viewing area of the display when displayed in the third display mode than when displayed in the second display mode.

15. The visual-display system of claim 14, wherein the first display mode is defined by the display of text for each of a plurality of menu items and the second display mode is defined by the display of text for only a single, currently-active, menu item, and the third display mode is defined by the display of text for the single, currently-active, menu item in a smaller size than a size displayed in the second display mode.

16. The visual-display system of claim 1, wherein the timeout period is predetermined and fixed for the visual-display system.

17. The visual-display system of claim 1, wherein the timeout period is user-definable.

18. The visual-display system of claim 1, wherein the display is one selected from the group consisting of: an liquid-crystal display (LCD), a plasma display, and an organic light-emitting diode display (OLED).

19. A portable electronic device having the visual-display system of claim 1.

20. The portable electronic device of claim 19, wherein the portable electronic device is one selected from the group consisting of: a digital camera, a video camera, a cellular phone, and a personal digital assistant (PDA).

21. A method for displaying menu information on a visual-display system comprising:
displaying at least one selectable menu option in a first display mode for a timeout period; and
after the timeout period, displaying the at least one selectable menu option in a second display mode, wherein the at least one selectable menu option occupies less space in the viewing area of the display when displayed in the second display mode than when displayed in the first display mode.

22. A visual-display system comprising:
a display defining a viewing area;
logic configured to display a plurality of selectable menu options in the viewing area;
logic configured to display at least one selectable menu option in a first display mode; and
logic configured to display the at least one selectable menu option in a second display mode in response to a timeout period;
wherein the at least one selectable menu option is less obstructive of the viewing area of the display when displayed in the second display mode than when displayed in the first display mode.

23. The system of claim 22, wherein the at least one selectable menu item occupies less space in the viewing area of the display when displayed in the second display mode than when displayed in the first display mode.
